(19) United States
(12) Patent Application Publication
(10) Pub. No.: US 2021/0220767 A1
(43) Pub. Date: Jul. 22, 2021

(54) HONEYCOMB BODIES WITH TRIANGULAR CELL HONEYCOMB STRUCTURES AND MANUFACTURING METHODS THEREOF

(71) Applicant: CORNING INCORPORATED, Corning, NY (US)

(72) Inventors: Douglas Munroe Beall, Painted Post, NY (US); Seth Thomas Nickerson, Corning, NY (US); Todd Parrish St Clair, Painted Post, NY (US); David John Thompson, Savona, NY (US); Danhong Zhong, Elmira, NY (US)

(21) Appl. No.: 17/058,239

(22) PCT Filed: May 28, 2019
(86) PCT No.: PCT/US2019/034151

§ 371 Date: Nov. 24, 2020

Related U.S. Application Data
(60) Provisional application No. 62/678,745, filed on May 31, 2018.

(51) Int. Cl. B01D 46/24; B01J 35/04; B01J 37/02; B01J 35/10; B01J 35/00; B01D 53/94

(52) U.S. Cl. CPC B01D 46/247; F01N 3/2803; B01D 46/2474; B01J 35/04; B01J 37/0215; B01J 35/1076; B01J 35/0026; B01D 53/94; B01D 2046/2433; B01D 2046/2437; B01D 2046/2477; B01D 2279/30; B01D 2255/9155; B01D 2255/9202; B01D 2255/9205; B01D 46/2429

(57) ABSTRACT

A honeycomb structure having a cellular honeycomb matrix of intersecting porous walls forming cell channels with triangular cross-sectional shapes and filleted vertices in the triangular cross-sectional shapes. The porous walls include % P≥40% and MPD>8 μm. The matrix includes a cell channel density of 150 cpsi to 600 cpsi (23.3 cpscm to 93 cpscm) and wall thicknesses of between 2 mils and 12 mils (between 51 μm to 300 μm). Honeycomb extrusion dies and methods of manufacturing the honeycomb body having triangular-shaped cell channels are provided, as are other embodiments.

This application claims the benefit of priority under 35 U.S.C. § 119 of U.S. Provisional Application Ser. No. 62/678,745 filed on May 31, 2018, the content of which is incorporated herein by reference in its entirety.

### FIELD

Embodiments of the disclosure relate to honeycomb bodies, and more particularly to honeycomb bodies with honeycomb structures comprising triangular cells.

### BACKGROUND

Ceramic honeycomb structures with relatively thin wall thickness can be utilized in exhaust after-treatment systems. As the walls become thinner, problems of low isostatic (ISO) strength may be encountered.

### SUMMARY

In one aspect, a honeycomb body is disclosed comprising a honeycomb structure or a matrix of triangular-shaped cell channels, the triangular-shaped cell channels having filleted vertices.

In another aspect, a honeycomb body is disclosed comprising a honeycomb structure or a cellular honeycomb matrix of intersecting porous walls forming cell channels with triangular cross-sectional shapes and filleted vertices in the triangular cross-sectional shapes. The porous walls comprise: % P≥40% and MPD>8 μm, and the matrix comprises: a cell channel density of 150 cpsi to 600 cpsi (23.3 cpscm to 93 cpscm) and wall thicknesses of between 2 mils and 12 mils (between 51 μm and 300 μm).

In another aspect, a method of manufacturing a honeycomb structure is disclosed comprising extruding a batch material through an extrusion die to form walls of a cellular honeycomb matrix of intersecting porous walls defining cell channels with triangular cross-sectional shapes and filleted vertices in the triangular cross-sectional shapes, the porous walls comprising: % P≥40% and MPD>8 μm; the matrix comprising: a cell channel density of 150 cpsi to 600 cpsi (23.3 cpscm to 93 cpscm) and wall thicknesses of between 2 mils and 12 mils (between 51 μm and 300 μm).

In another aspect, a thin-walled honeycomb body is disclosed comprising a cellular honeycomb matrix of intersecting porous walls forming cell channels with triangular cross-sectional shapes and filleted vertices in the triangular cross-sectional shapes, the porous walls comprising: % P≥40% and 8 μm<MPD<30 μm; and the matrix comprising: a cell channel density of 200 cpsi to 400 cpsi (31 cpscm to 62 cpscm) and wall thicknesses of 6 mils (152 μm) or less.

Numerous other features and aspects are provided in accordance with these and other embodiments of the disclosure. Further features and aspects of embodiments will become more fully apparent from the following detailed description, the claims, and the accompanying drawings.

### BRIEF DESCRIPTION OF THE DRAWINGS

The accompanying drawings, described below, are for illustrative purposes and are not necessarily drawn to scale. The drawings are not intended to limit the scope of the disclosure in any way. Like numerals are used throughout the specification and drawings to denote like elements.

FIG. 1A illustrates a partially cross-sectioned side view of an extruder apparatus according to one or more embodiments.

FIG. 1B illustrates a perspective side view of an extruder apparatus with a filleted triangular cross-sectional shaped honeycomb extrudate being extruded therefrom according to one or more embodiments.

FIG. 2 illustrates an isometric view of a honeycomb structure comprising filleted triangular-shaped cell channels according to one or more embodiments.

FIG. 3A illustrates an inlet side end view of a honeycomb structure comprising filleted triangular-shaped cell channels according to one or more embodiments.

FIG. 3B illustrates an enlarged, partial, inlet-side end view of a plurality of cell channels of the honeycomb structure comprising filleted triangular-shaped cell channels of FIG. 3A according to one or more embodiments.

FIG. 3C illustrates an enlarged end view of two adjacent filleted triangular-shaped cell channels of the honeycomb structure of FIG. 3B according to one or more embodiments.

FIG. 4A illustrates an enlarged end view of a traditional triangular-shaped cell channel with an on-wall wash coat applied thereto.

FIG. 4B illustrates an enlarged end view of a triangular-shaped cell channel comprising filleted vertices and an on-wall wash coat applied thereto according to one or more embodiments.

FIG. 5A illustrates an enlarged end view of a traditional triangular-shaped cell channel with an in-wall wash coat applied thereto.

FIG. 5B illustrates an enlarged end view of a triangular-shaped cell channel comprising filleted vertices and an in-wall wash coat applied thereto according to one or more embodiments.

FIG. 6 illustrates a partial cutaway view of a catalytic converter comprising the honeycomb structure comprising filleted triangular-shaped cell channels of FIGS. 2-3C according to one or more embodiments.

FIG. 7 illustrates a schematic diagram of an internal combustion engine comprising the catalytic converter of FIG. 6 in the exhaust stream according to one or more embodiments.

FIG. 8A illustrates a front view of a honeycomb extrusion die configured to extrude the honeycomb body comprising filleted triangular-shaped cell channels of FIGS. 2-3C according to one or more embodiments.

FIG. 8B illustrates a partial cross-sectional side view of the honeycomb extrusion die of FIG. 8A according to one or more embodiments.

FIG. 9 illustrates a flowchart describing a method of manufacturing a honeycomb structure according to one or more embodiments.

### DETAILED DESCRIPTION

Reference will now be made in detail to the example embodiments of this disclosure, which are illustrated in the accompanying drawings. In describing the embodiments, numerous specific details are set forth in order to provide a thorough understanding of the disclosure. However, it will be apparent to a person of ordinary skill in the art that embodiments of the disclosure may be practiced without some or all of these specific details. In other instances, well-known structural or functional features and/or process steps may have not been described in detail so as not to unnecessarily obscure embodiments of the disclosure. Structural and functional features of the various embodiments described herein may be combined with each other, unless specifically noted otherwise.

After-treatment of exhaust gas from internal combustion engines may use catalytic material or catalysts supported on high-surface-area substrates and, in the case of some engines, a catalyzed or uncatalyzed filter for the removal of particles. Filters and catalyst substrates in these applications may be refractory, thermal shock resistant, stable under a range of partial pressure of oxygen, pO2, conditions, non-reactive with the catalyst system, and offer low resistance to exhaust gas flow. Porous ceramic flow-through honeycomb substrates and wall-flow honeycomb filters can be made utilizing the “honeycomb bodies” described herein.

A honeycomb body comprising a honeycomb structure can be formed from a batch material mixture, for example, a ceramic-forming batch composition, which comprises inorganic materials that may comprise ceramics or ceramic precursors, or both, an organic binder (e.g., methylcellulose), and a liquid vehicle (e.g., water) and optional pore formers, rheology modifiers, and the like. When fired, the ceramic-forming batch composition is transformed or sintered into a porous ceramic material, for example, a porous ceramic suitable for exhaust after-treatment purposes. The formed ceramic(s) may be cordierite, aluminum titanate, mullite, combinations of cordierite, mullite, and aluminum titanate (e.g., such as cordierite, mullite, and aluminum titanate (CMAT)), alumina, silicon carbide, silicon nitride, and the like, and combinations thereof. Other suitable ceramic-forming batch material mixtures may be used.

The honeycomb structure can be formed by an extrusion process where the ceramic-forming batch composition is extruded into as a honeycomb extrudate, cut, dried, and fired to form the ceramic honeycomb structure. The extrusion process can be performed using a hydraulic ram extrusion press, a two stage de-airing single auger extruder, a twin-screw extruder, or the like, with an extrusion die in a die assembly attached to the discharge end. Other suitable extruder apparatus or other devices may be used to form the honeycomb structures described herein.

Honeycomb extrusion dies employed to produce such honeycomb structures can be multi-component assemblies including, for example, a wall-forming die body combined with a skin-forming mask. For example, U.S. Pat. Nos. 4,349,329 and 4,298,328 disclose die structures including skin-forming masks. The die body preferably incorporates batch feedholes leading to, and intersecting with, an array of discharge slots formed in the die face, through which the ceramic-forming batch composition is extruded to form a plurality of filleted vertex, triangular shaped cell channels. The extrusion process forms an interconnecting array of crisscrossing walls forming a central cellular honeycomb matrix. A mask can be employed in conjunction with a skin-forming region of the extrusion die to form an outer peripheral skin. The mask can be a ring-like circumferential structure, such as in the form of a collar, defining the periphery of the skin of the honeycomb structure. The circumferential skin of the honeycomb structure can be formed by extruding the ceramic-forming batch composition between the mask and the central cellular honeycomb structure-forming portion of the die body.

The extruded material, referred to as a honeycomb extrudate, can be cut to create the honeycomb bodies, such as to form honeycomb structures shaped and sized to meet the needs of engine manufacturers. The honeycomb extrudate can alternatively be in the form of honeycomb segments, which can be connected or bonded together to form honeycomb structures. These honeycomb segments and resultant honeycomb structures can be any size or shape. As the honeycomb extrudates are extruded, an external extruded surface such as an external peripheral surface can be provided along the length of the honeycomb extrudate. In some embodiments, the ends of the honeycomb structure are not plugged, although certain passages may be plugged in a pattern if desired (e.g., to produce a honeycomb particulate filter or a partial filter wherein less than 50% of the cell channels are plugged).

The demand for thin-walled honeycomb structures, such as honeycomb structures having wall thicknesses of 0.006 inches (0.10 mm) or less, is increasing substantially. At the same time, honeycomb structures incorporating greater numbers of cells, for example, greater than about 400 cpsi (greater than about 62 cpscm) are also in demand. Although current extrusion dies can be adapted to the extrusion of thin-walled honeycomb structures with no gross forming defects, certain new problems unique to these thin-walled honeycomb structures may be encountered. One particularly vexing problem is that such thin-walled honeycomb structures can cause lower ISO strength in fired ceramic honeycomb structure, which may lead to cracking during canning and other operations, or even in final use.

In one advantage, the honeycomb structures comprising filleted, triangular-shaped cell channels disclosed herein have higher ISO strengths than traditional honeycomb structures having comparable microstructure and macrostructure (cpsi and wall thickness). In some embodiments, the honeycomb structures may provide a higher ISO strength and lower cell density than traditional honeycomb structures, but with similar emission processing characteristics. Triangular-shaped cell channels in the honeycomb structures provide high ISO strength, but in traditional honeycomb bodies, the triangular-shaped channels do not allow a wash coat to be applied efficiently. For example, the wash coats can puddle at the sharp vertices of the triangles, resulting in wasted wash coat thereat.

In one aspect, the vertices of the triangular-shaped channels described herein are filleted, which provides for a fairly uniform application of wash coat on the intersecting porous walls and may also improve the ISO strength of the honeycomb structures. In another advantage, the honeycomb structures comprising filleted, triangular-shaped cell channels disclosed herein can also have improved chipping resistance while maintaining high thermal shock resistance and improved ISO strength. The honeycomb structures may be configured for use in catalytic converters and/or particulate filters. For example, the honeycomb structures described herein may be substrates for deposit of a wash coat comprising one or more catalyst or other metals such as platinum, palladium, rhodium, combinations, or the like. These one or more metals catalyze a reaction with an exhaust stream, such as of an exhaust stream from an internal combustion engine exhaust (e.g., automotive engine or diesel engine). Other metals may be added such as nickel and manganese to block sulfur absorption by the wash coat. The reaction may oxidize carbon monoxide and oxygen into carbon dioxide, for example. Moreover, modern three-way catalysts may also be used to reduce oxides of nitrogen (NOx) to nitrogen and oxygen. Additionally, unburnt hydrocarbons may be oxidized to carbon dioxide and water.

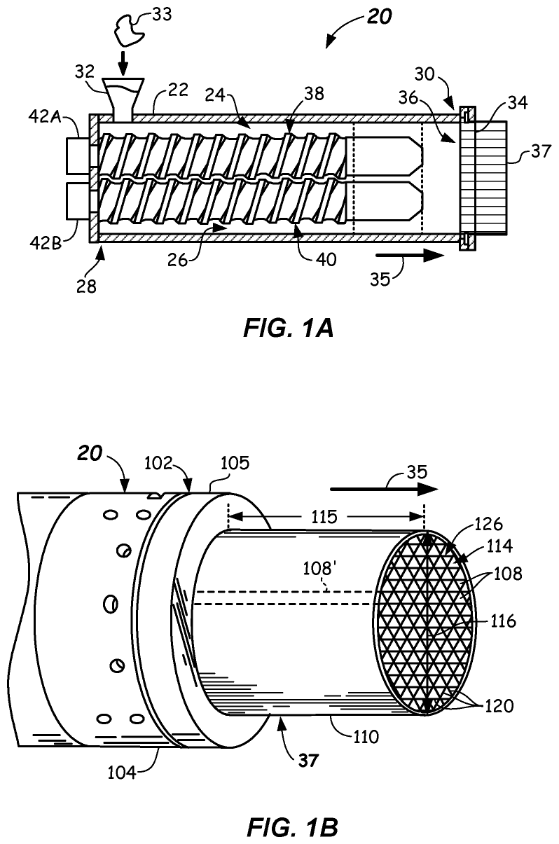

These and other embodiments of honeycomb structures comprising filleted vertex, triangular-shaped cell channels and manufacturing methods according to the present disclosure are further described below with reference to FIGS. 1A-9 herein.

FIG. 1A shows a partially cross-sectioned side view of an embodiment of an extruder apparatus 20, such as a continuous twin-screw extruder apparatus. The extruder apparatus 20 comprises a barrel 22 comprising a first chamber portion 24 and a second chamber portion 26 formed therein and in communication with each other. The barrel 22 can be monolithic or it can be formed from a plurality of barrel segments connected successively in the longitudinal (e.g., axial) direction. The first chamber portion 24 and the second chamber portion 26 extend through the barrel 22 in the longitudinal direction between an upstream side 28 and a downstream side 30. At the upstream side 28 of the barrel 22, a supply port 32, which can comprise a hopper or other material supply structure, may be provided for supplying a batch material 33 to the extruder apparatus 20. Batch material 33 can be provided to the supply port 32 in a continuous or semi-continuous manner by supplying batch material 33 in pugs, smaller globules, formed particles, or any other suitable form.

A honeycomb extrusion die 34 is provided at a discharge port 36 at the downstream side 30 of the barrel 22 for extruding the batch material 33 into a desired shape, such as honeycomb extrudate 37. The honeycomb extrusion die 34 may be coupled with respect to a discharge port 36 of the barrel 22, such as at an end of the barrel 22. The honeycomb extrusion die 34 can be preceded by other structures, such as a generally open cavity, a screen and/or homogenizer (not shown), or the like to facilitate the formation of a steady plug-type flow front as the batch material 33 reaches the honeycomb extrusion die 34.

As shown in FIG. 1A, a pair of extruder screws are mounted in the barrel 22. A first screw 38 is rotatably mounted at least partially within the first chamber portion 24 and a second screw 40 is rotatably mounted at least partially within the second chamber portion 26. The first screw 38 and the second screw 40 may be arranged approximately parallel to each other, as shown, though they may also be arranged at various angles relative to each other. The first screw 38 and the second screw 40 may also be coupled to driving mechanisms, such as drive motors, located outside of the barrel 22 for rotation in the same or different directions. It is to be understood that both the first screw 38 and the second screw 40 may be coupled via a transmission or gearing mechanism to a single driving mechanism (not shown) or, as shown, to individual driving mechanisms 42A, 42B. The first screw 38 and the second screw 40 move the batch material 33 through the barrel 22 with pumping and mixing action in an extrusion direction 35, which is also referred to as an axial direction.

FIG. 1B shows an end of the extruder apparatus 20 and a honeycomb extrudate 37 being extruded therefrom. The extruder apparatus 20 is shown with an extruder front end 102 where the batch material 33 exits the extruder apparatus 20 as the honeycomb extrudate 37. An extruder cartridge 104 located proximate the extruder front end 102 may comprise extrusion hardware such as the honeycomb extrusion die 34 (not shown in FIG. 1B) and a skin-forming mask 105. The honeycomb extrudate 37 comprises a first end face 114 and a length 115 extending between the extruder front end 102 and the first end face 114. The honeycomb extrudate 37 may comprise a plurality of channels 108 having filleted-vertex, triangular-shaped cell channels and an outer peripheral skin 110. A plurality of intersecting walls 120 may intersect with each other and form the channels 108 that extend in the axial direction 35. For example, intersecting walls 120 forming a single channel 108′ shown extending in the axial direction 35 are shown by dashed lines for illustration. A maximum cross-sectional dimension perpendicular to the axial direction 35 is indicated by dimension 116. For example, when the cross-section of the first end face 114 of the honeycomb extrudate 37 shown is circular, the maximum dimension 116 may be a diameter of the circular first end face 114. When the cross-section of the first end face 114 of the honeycomb extrudate 37 is rectangular, the maximum dimension 116 may be a diagonal of the rectangular first end face 114. The cross-sectional shape of the first end face 114 can be elliptical, race track shaped, square, rectangular non-square, triangular or tri-lobed, asymmetrical, symmetrical, or other desired shapes, and combinations thereof.

Upon exiting the extruder apparatus 20 in the axial direction 35, the honeycomb extrudate 37 may stiffen and comprise a honeycomb structure or honeycomb matrix 126 of intersecting walls 120 that extend axially and form the channels 108 and the outer peripheral skin 110, which also extend axially. The outer peripheral skin 110 may be a skin layer that is extruded along with the honeycomb matrix 126 from the same batch material 33 and can be an integrally formed co-extruded skin. The honeycomb extrudate 37 can be cut or otherwise formed into green honeycomb bodies comprising honeycomb structures. As used herein, green honeycomb structure refers to an extruded, or extruded and dried structure prior to firing.

While extrusion is illustrated as horizontal orientation in FIG. 1B, this disclosure is not so limited and extrusion can be horizontal, vertical, or at some incline thereto.

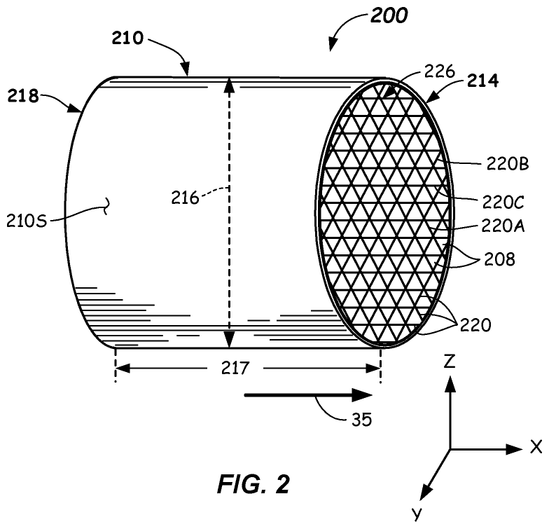

With additional reference to FIG. 2, batch material 33 (FIG. 1A) upon exiting the extruder front end 102 (FIG. 1B) is formed into a honeycomb extrudate 37 (FIG. 1B) that can be cut to length, dried, and fired thus forming a honeycomb body 200 of length 217 extending between a first end face 214 and a second end face 218. Cutting can be achieved by wire cutting, saw cutting, combinations of cutting and grinding such as with an abrasive wheel, cutting with a band saw or reciprocating saw, or other cutting method.

The porous walls 220, after firing, may comprise a median pore diameter (MPD) of 8 μm≤MPD≤30 μm in some embodiments. In other embodiments, the MPD≥8 μm. The breadth Db of the pore size distribution of the open, interconnected porosity may be Db≤1.5, or even Db≤1.0, wherein Db=((D₉₀−D₁₀)/D₅₀), wherein D₉₀ is an equivalent spherical diameter in the pore size distribution of the intersecting porous walls 220 where 90% of the pores have an equal or smaller diameter and 10% have a larger diameter, and D₁₀ is an equivalent spherical diameter in the pore size distribution where 10% of the pores have an equal or smaller diameter, and 90% have a larger diameter. The median pore diameter (MPD) and breadth Db of the pore size distribution may be measured by mercury porosimetry, for example.

The honeycomb body 200 comprises a honeycomb matrix 226 of porous walls 220 forming adjoining channels 208. As shown in FIG. 2, the channels 208 have triangular transverse cross-sections in a Y-Z plane as shown. The channels 208 may be formed by the intersections of a plurality of first walls 220A, second walls 220B, and third walls 220C. The third walls 220C as depicted in FIG. 2 are parallel to a horizontal plane. The second walls 220B can intersect the first walls 220A at an angle (e.g., about 60°). The third walls 220C can intersect both the first walls 220A and the second walls 220B at an angle to complete the transverse triangular shapes of the channels 208. In the embodiments of the triangular shapes of the channels 208 being equilateral triangles, the first walls 220A, the second walls 220B, and the third walls 220C intersect each other at angles of about 60°. The porous walls 220 and, thus, the channels 208 extend in the axial direction 35 between the first end face 214 and the second end face 218, wherein the axial direction may extend normal to the first end face 214. A maximum cross-sectional dimension perpendicular to the axial direction 35 is indicated by diameter 216.

The first end face 214 can be an inlet face and the second end face 218 can be an outlet face separated by a length 217. The peripheral skin 210 of the honeycomb body 200 can extend axially between the first end face 214 and the second end face 218 and completely surround the periphery. In some embodiments described herein, the honeycomb body 200 can be excised from a longer log-shaped green honeycomb structure that can undergo further firing. In other embodiments, the green honeycomb structure can be an appropriately-sized green honeycomb structure substantially ready for firing that produces the length 217 after firing.

The porous walls 220 forming the channels 208 of the honeycomb body 200 may be coated in some embodiments. For example, if the honeycomb body 200 is used in a catalytic converter, or in some cases, as a wall flow filter, or partial filter, the porous walls 220 can be coated with a catalyst-containing coating, such as a wash coat for exhaust after-treatment. In such applications, the open and interconnected porosity (% P) of the porous walls 220 may be between 10% and 30% or even between 15% and 25% in non-filter embodiments, or greater than or equal to 40% in filter embodiments. In other embodiments where the honeycomb body 200 comprises plugs and is used as a particulate filter, the porous walls 220 are suitably porous (e.g., 30%-70% porosity) to allow exhaust gas to pass through the porous walls 220. For example, the open and interconnected porosity (% P) of the porous walls 220, after firing, may be % P≥40%, % P≥45%, % P≥50%, % P≥60%, or even % P≥65% in some embodiments. In some embodiments, the open and interconnected porosity of the intersecting porous walls 220 may be 40%≤% P≤70%, or even 40%≤% P≤60%, or even 45%≤% P≤55%. Other values of % P may be used. Porosity (% P) as recited herein is measured by a mercury porosity measurement method.

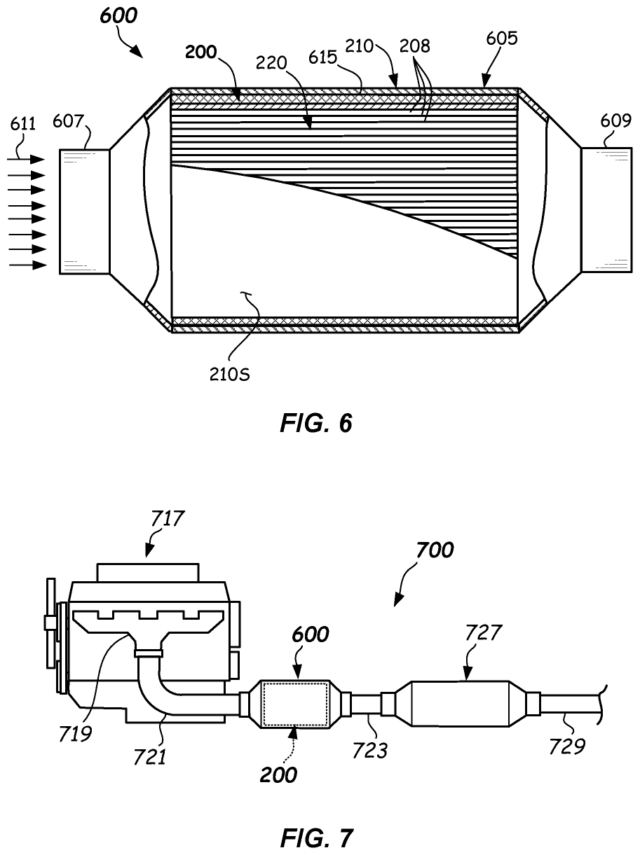

The porous walls 220 of the honeycomb body 200 may be made of an intersecting matrix of thin walls of a suitable porous material (e.g., porous ceramic). The catalytic material(s) may be suspended in a washcoat of inorganic particulates and a liquid vehicle and applied to the porous walls 220 of the honeycomb body 200, such as by coating. In other embodiments, the wash coat may be applied in the pores in the porous walls 220 of the honeycomb body 200. Thereafter, the coated honeycomb body 200 may be wrapped with a cushioning material and received in a can (or housing) via a canning process as shown in FIG. 6.

As part of this canning process, the honeycomb body 200 may be subjected to appreciable isostatic compression stresses. In honeycomb structures having wall thicknesses of all the walls of 0.006 inch (0.15 mm) or less, and especially in ultra-thin walled honeycomb bodies having wall thickness of all the walls of 0.003 inch (0.08 mm) or less, these ISO stresses can, in some cases, cause fracture of the porous walls 220 thereof. The predominant mechanism of fracture has been determined by the inventors to be buckling and/or significant deformation of the walls 220. Thus, thin-walled honeycomb designs that enable higher ISO strength and therefore less buckling may provide certain advantages, in terms of less wall fracture during canning as well as during handling and use.

Honeycomb bodies 200 comprising triangular-shaped channels 208 provide high isostatic strength, but traditional honeycomb structures comprising triangular-shaped channels have deficiencies. Triangular-shaped channels have at least two vertices with acute angles and equilateral triangular-shaped cell channels have vertices with three acute angles, each being 60°. These vertices act as pockets that hold wash coat that would otherwise be applied to or in the porous walls. Thus, traditional triangular-shaped channels use excessive wash coat and may have reduced hydraulic diameters and open frontal areas (OFA), which are detrimental to the operation of catalytic converters and filters. Traditional triangular-shaped channels having on-wall wash coats have reduced hydraulic diameters and non-uniform wash coat applications. For example, the vertices of the triangular-shaped channels have thick wash coats relative to the thicknesses of wash coats at other portions of the triangular channels. Thus, excessive wash coat is used in traditional honeycomb structures having triangular-shaped channels.

In one or more embodiments, the honeycomb body 200 comprises triangular-shaped channels 208 wherein the vertices of the triangular-shaped channels 208 comprise fillets that are rounded and prevent excessive wash coat from accumulating at the vertices. Thus, wash coats are applied more uniformly than in traditional honeycomb structures. In addition, catalysts in the wash coat are more accessible to exhaust gases than catalysts in traditional honeycomb structures.

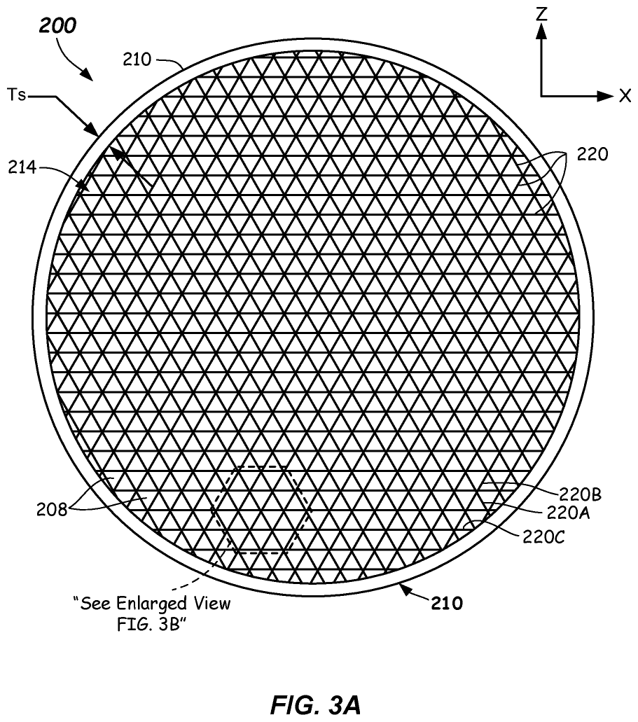

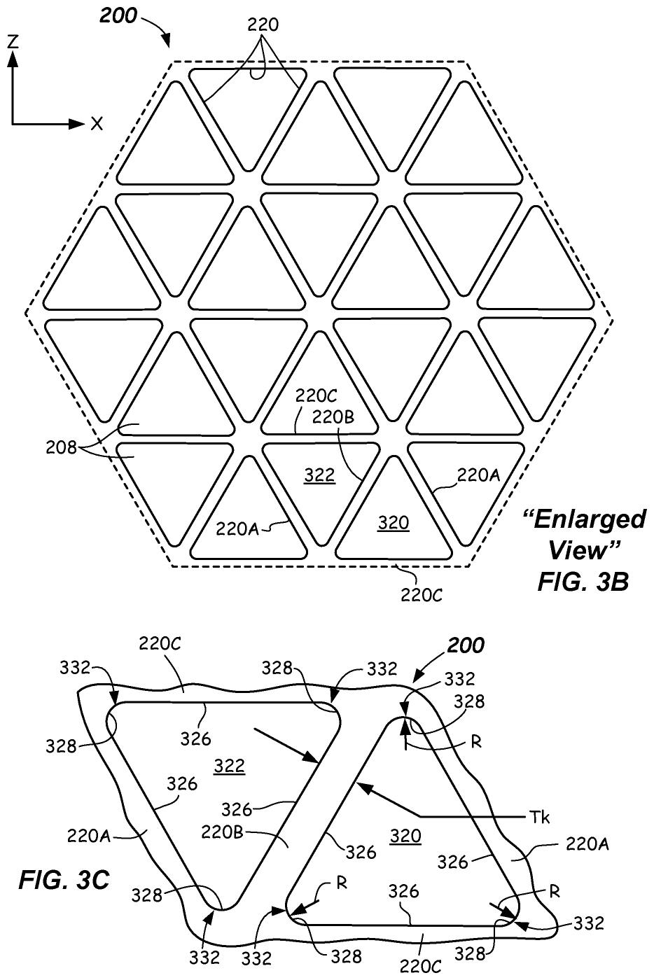

Reference is now made to FIGS. 3A and 3B. FIG. 3A illustrates an end view of the first end face 214 of the honeycomb body 200. FIG. 3B illustrates a partial, enlarged view of the first end face 214 of the honeycomb body 200. The depicted embodiment of the honeycomb body 200 for FIGS. 3A and 3B comprises the plurality of intersecting porous walls 220 forming triangular-shaped channels 208. The triangular-shaped channels 208 may extend to and intersect with the skin 210 around the periphery of the honeycomb body 200. Channels 208 proximate the skin 210 may comprise walls that comprise the skin 210 and may not be triangular and may or may not include the filleted vertices described herein. The porous walls 220 in this embodiment, intersect with one another (e.g., at 60° angles) and form the plurality of cell channels 208 having equilateral triangle shapes in transverse cross-section. The equilateral triangle shapes of the channels 208 have maximum angles at all the vertices of the channels 208. Other triangular shapes, such as isosceles triangular shapes, may be used in other embodiments. The channels 208 extend longitudinally (e.g., substantially parallel with one another) and along an axial flow axis extending between the first end face 214 and the second end face 218 (FIG. 2) of the honeycomb body 200.

Additional reference is made to FIGS. 3B and 3C to illustrate a channel 320 and a channel 322 that are similar to other cell channels 208, except those channels that are adjacent the skin 210 and are not triangular in transverse cross-section. For example, channels 208 abutting the curved surface of the skin 210 may not be triangular in transverse cross-section or may have different triangular shapes from channels 208 that do not abut the skin 210. The channel 320 and the channel 322 each have three sides 326 and three vertices 328 that may be filleted. The filleted vertices define corner radii of the channels 208, and 320, 322. Corner radii may be continuous radii having a constant radius value.

The channel 320 and the channel 322 share a common porous wall 220B between their adjacent sides 326. The porous wall 220B between the adjacent sides 326 has a transverse wall thickness Tk, which may be between 2 mils and 12 mils (51 μm to 300 μm). In some embodiments, the transverse wall thicknesses Tk may be less than 6 mils (150 μm) or less than 4 mils (101 μm). In some embodiments, all the porous walls 220 between adjacent sides 326 of adjacent channels 208 have the same transverse wall thickness Tk, but they need not. The transverse wall thickness Tk of the porous walls 220 may be constant along an axial length (Y—perpendicular to X and Z) of the porous walls 220.

As described above, the vertices 328 of the channels 208 may comprise fillets 332, which cause the vertices 328 to be rounded. For example, the filleted vertices 328 of the channel 320, which may be representative of all vertices of the channels 208, have radii R, which may be a continuous radius of 0.001 inch (0.0254 mm) or greater. The channel 320 depicted in FIG. 3C shows fillets 332 where the vertices 328 of the transverse triangular shapes of the channel 320 are located. The regions where the fillets 332 are located prevent puddling of the applied washcoat. This allows a portion of catalysts in the wash coat located in these corner regions to react with an exhaust stream flowing through the honeycomb structure, so the catalyst will be used efficiently.

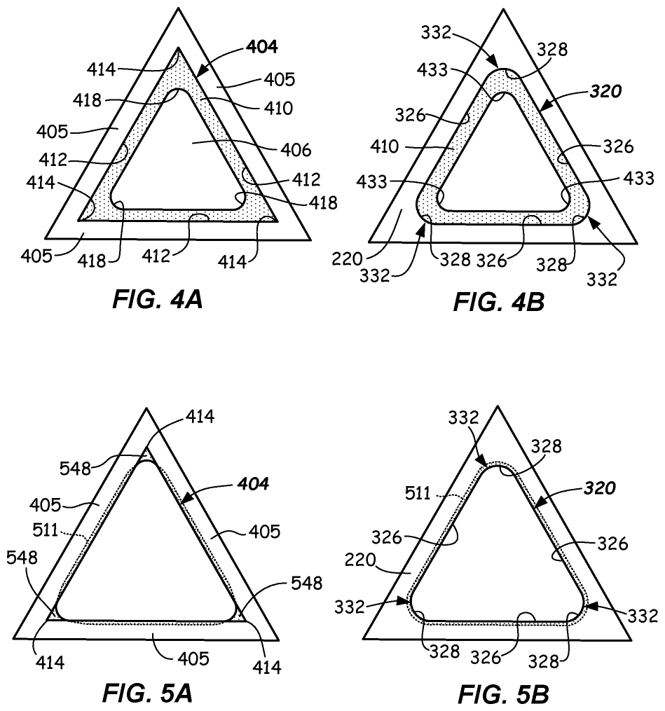

FIG. 4A illustrates an on-wall wash coat 410 applied to walls 405 of a traditional triangular-shaped channel 404. FIG. 4B illustrates an on-wall wash coat 410 applied to porous walls 220 of the triangular-shaped channel 320. The walls 405 of the traditional channel 404 include sides 412 that intersect at vertices 414 that are not rounded and/or filleted. The application of the wash coat 410 on the sides 412 yields a flow channel 406 within the traditional channel 404 that includes vertices 418 of the washcoat proximate the vertices 414 of the traditional channel 404. The vertices 418 of the wash coat 410 are rounded by the nature of the application of the wash coat 410. As shown in FIG. 4A, there is a significant volume of wash coat 410 between the vertices 414 of the traditional channel 404 and the vertices 418 of the flow channel 406. As also shown in FIG. 4A, the wash coat 410 is not applied uniformly due to the volume of wash coat 410 between the vertices 414 of the traditional channel 404 and the vertices 418 of the flow channel 406. This non-uniform wash coat 410 uses a significant amount of wash coat 410 between the vertices 418 and the vertices 414, and that wash coat 410 will not be exposed to an exhaust stream flowing through the flow channel 406. For example, the wash coat 410 between the vertices 418 and the vertices 414 may be too thick for the entire wash coat 410 proximate the vertices 414 to react with the exhaust stream.

The channel 320 shown in FIG. 4B includes the fillets 332, so the vertices 328 are rounded. The on-wall wash coat 410 applied to the sides 326 of the porous walls 220 of the channel 320 follows the filleted vertices 328 and may be applied uniformly to all surfaces (e.g., sides 326 and vertices 328) of the channel 320. The uniform wash coat 410 yields a uniform thickness, even in the vertices 328 of the channel 320. Accordingly, the thickness of the wash coat 410 between the vertices 328 of the channel 320 and the vertices 433 of the wash coat 410 is the same as the thicknesses of other areas of the wash coat 410. Thus, the channel 320 includes a uniform wash coat 410 and does not have pockets where the wash coat 410 is not used efficiently as with the traditional channel 404.

FIG. 5A illustrates the traditional channel 404 including an in-wall wash coat (shown as dotted area) applied within the walls 405. As described above, the traditional channel 404 has vertices 414 that are not filleted. During application of the wash coat, pockets 548 of wash coat accumulate proximate the vertices 414. The wash coat accumulated in the pockets 548 is not within the walls 405 and is excess wash coat, which increases the cost of the honeycomb structure including the traditional channel 404. Moreover, the wash coat in the walls 405 behind the pockets 548 is not exposed to the exhaust stream and is thus applied inefficiently and expensively and is wasted.

FIG. 5B, on the other hand, illustrates the channel 320 including an in-wall wash coat 511 (shown dotted) applied to the porous walls 220. As shown in FIG. 5B, the fillets 332 prevent the in-wall wash coat 511 from accumulating in the vertices 328 of the channel 320. Accordingly, there is no excessive in-wall wash coat 511 applied to the channel 320 and no wash coat is wasted.

Referring again to FIG. 3A, the honeycomb body 200 can have a channel density or cell density of greater than or equal to 600 cells per square inch (cpsi) (93 cells per square centimeter (cpscm)). However, in other embodiments, the cell density may be between 150 cpsi and 600 cpsi (23.3 cpscm to 93 cpscm). In some embodiments, the cell density may be between 200 cpsi and 400 cpsi (between 31 cpscm to 62 cpscm). In some embodiments, the cell density is approximately 300 cpsi (46.5 cpscm).

In the embodiments described herein, the porous walls 220 of the honeycomb body 200 described herein may comprise open, interconnected porosity and the porous walls 220 may be made of a porous ceramic material or other suitable porous material that can withstand high temperatures in use, such as those encountered when used in engine exhaust after-treatment applications. For example, the porous walls 220 may be made of a ceramic material, such as cordierite, aluminum titanate, mullite, a combination of cordierite, mullite and aluminum titanate (CMAT), alumina (Al₂O₃), silicon carbide (SiC), silicon aluminum oxynitride (Al₆O₂N₆Si), zeolite, enstatite, forsterite, corrundum, spinel, sapphirine, periclase, combinations of the afore-mentioned, and the like. Other suitable porous materials may be used, such as fused silica or porous metal. Pore formers may be added to the batch material to form the porous walls 220 having specific porosities.

In the case of ceramics, the porous walls 220 may be initially formed as non-porous walls during an extrusion process wherein a suitable plasticized batch material 33 (FIG. 1A) of inorganic and organic batch components and a liquid vehicle (e.g., deionized water) and possibly extrusion aids are extruded through the honeycomb extrusion die 34. The green honeycomb extrudate 37 produced may then be dried and fired to produce the described honeycomb body 200 comprising porous walls 220 as described herein.

The honeycomb body 200 may provide similar characteristics as honeycomb structures having different transverse channel shapes and higher cell densities. The lower cell density may lower the cost of the honeycomb body 200 by lowering the cost of the honeycomb extrusion die 34 (FIG. 1A). Catalytic efficiency is highest for matrices of channels with high geometric surface area, which are provided by channels 208 having triangular transverse cross-sections. The open frontal area (OFA) and hydraulic diameter of the honeycomb body 200 are proportional to gas flow restrictions through the honeycomb body 200. In some embodiments, the OFA is 83% or greater. In some embodiments, the hydraulic diameter of the channels 208 is 1.0 mm or greater.

Reference is made to Table 1, which shows honeycomb structure attributes as functions of different transverse channel shapes (Square, Hexagonal (Hex), and Triangle) having the same hydraulic diameters. The honeycomb bodies 200 are compared to a honeycomb structure having 400/4 square channels.

TABLE 1
Comparisons

| Shape | Square | Hex | Triangle |
|---|---|---|---|
| Cell density | 400 | 460 | 306 |
| (cpsi) | | | |
| Web Thick (mils) | 4 | 4 | 4 |
| Hyd Dia (mm) | 1.17 | 1.17 | 1.17 |
| OFA (%) | 84.7 | 84.7 | 84.7 |
| GSA (mm⁻¹) | 2.90 | 2.89 | 2.89 |
| Fanning friction | 14.2 | 15.0 | 13.0 |
| factor | | | |

As shown in Table 1, the honeycomb structure having hexagonal-shaped channels has a cell channel density of 460 cpsi to achieve the same hydraulic diameter. The honeycomb body 200 with the triangular-shaped channels 208 has a cell density of 306 cpsi. All three channel geometries have equivalent hydraulic diameters (Hyd Dia), open frontal areas (OFA), and geometric surface areas (GSA). However, the Fanning friction factor is significantly less for the honeycomb body 200. Specifically, the Fanning friction factor is 13.0 for the honeycomb body 200, 14.2 for the honeycomb structure having square-shaped channels, and 15.0 for the honeycomb structure having hexagonal-shaped (Hex) channels. Accordingly, the airflow resistance through the honeycomb body 200 with attributes of Table 1 is significantly less than the other geometries. By having a lower cell channel density, the honeycomb extrusion die 34 used to extrude the honeycomb body 200 may be less expensive to manufacture. For example, the walls 220A, 220B, 220C may be made with straight cuts and fewer walls may be required than with the square and hexagonal shapes.

The aforementioned benefits of the honeycomb body 200 over other structures may be recognized with the honeycomb body 200 having % P≥40%, MPD>8 μm, cell channel density of 150 cpsi to 600 cpsi (23.3 cpscm to 93 cpscm), and wall thicknesses of between 2 mils and 12 mils (between 51 μm and 300 μm). In some embodiments, 40%≤% P≤70%. In some embodiments, 8 μm<MPD<30 μm. In some embodiments, the cell channels may have hydraulic diameters of 1.00 mm or greater. In some embodiments, the honeycomb body 200 may have an OFA of 83% or more.

The honeycomb body 200 of FIGS. 2 and 3A may comprise a skin 210 on an outer radial periphery of the honeycomb body 200 defining an outer peripheral surface thereof. The skin 210 may be extruded during the extrusion manufacture or may be an after-applied skin in some embodiments, i.e., applied as ceramic-based skin cement onto an outer periphery (e.g., a machined outer periphery) of a fired ceramic honeycomb. The skin 210 may comprise a skin thickness Ts that can be substantially uniform about the radial periphery of the honeycomb body 200 when extruded, for example. The skin thickness Ts may be between about 0.1 mm to 100 mm, or even between 0.1 mm to 10 mm, or even between 0.005 mm and 0.1 mm, for example. In some embodiments, the skin thickness Ts may be between three and four times the wall thickness Tk (FIG. 3C) of the porous walls 220. Other skin thicknesses Ts may be used.

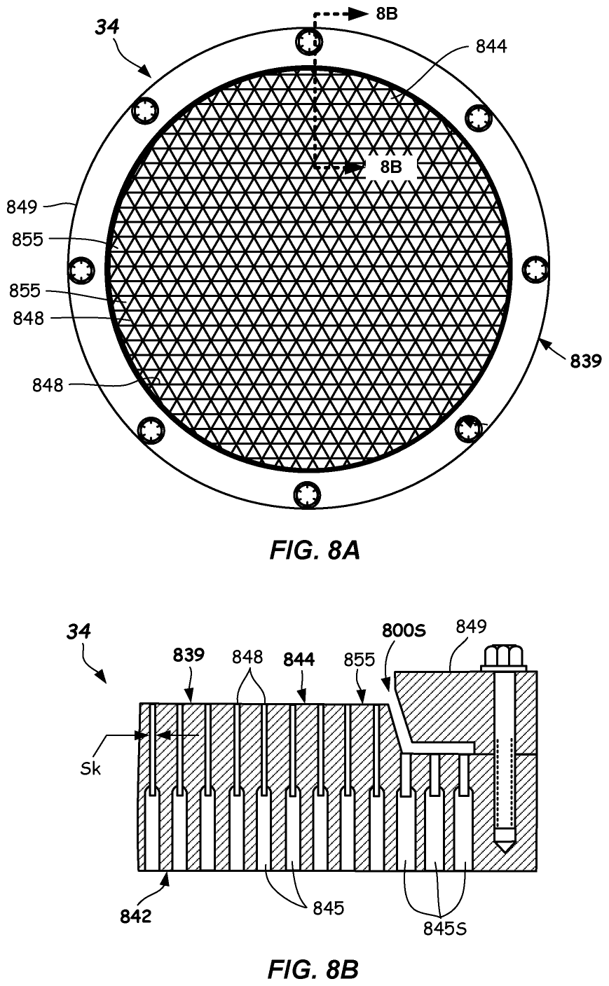

Apparatus and methods for skinning articles, such as honeycomb bodies are described in U.S. Pat. No. 9,132,578, for example. Other suitable skinning methods may be used. In all embodiments described herein, the porous walls 220 intersect and may extend continuously across the honeycomb body 200 between sections of the skin 210 in the different directions as shown by the walls 220A, 220B, and 220C. As will be apparent, some configurations of the porous walls 220 may have definite benefits in terms of reducing extrusion die cost, as wire EDM, abrasive slotting wheel, or other relatively low-cost manufacturing methods may be used. In these embodiments, the respective slots of the honeycomb extrusion die 34 (FIG. 1A) extend entirely across the outlet face of the honeycomb extrusion die 34 in straight lines, such as shown in FIG. 8A.

In some embodiments, a honeycomb assembly may be produced by adhering together multiple ones of honeycomb structures (e.g., having square, rectangular, hexagonal, and/or pie-shaped outer perimeter shapes). Each of the honeycomb structures may comprise the channels 208 as described herein. Any suitable cement mixture may be used for adhering together the multiple honeycomb structures to form the honeycomb assembly. For example, a cement mixture such as is described in WO 2009/017642 may be used, for example. Other suitable cement mixtures may be used. Any suitable outer periphery shape of the honeycomb assembly may be used, such as square, rectangular, circular, triangular or tri-lobed, elliptical, oval, race track, other polygonal shape, and the like. A suitable skin (e.g., like skin 210) may be applied around the outer periphery of the honeycomb assembly in some embodiments.

Referring now to FIG. 6, a catalytic converter 600 comprising the honeycomb body 200 of FIG. 2 is shown. In the depicted embodiment, the honeycomb body 200 is received inside of a can 605, such as a metal housing or other rigid confining structure. The can 605 may comprise a first end cap comprising an inlet 607 configured to receive engine exhaust flow 611 therein, and a second end cap comprising an outlet 609 configured to exhaust a gas flow, wherein a percentage of an undesirable species (e.g., NOx, CO, HC, or SOx) in the engine exhaust flow 611 has been reduced by passing through the channels 208 of the honeycomb body 200 and interacting with catalyst provided on and/or in the porous walls 220. The skin 210 of the honeycomb body 200 may have a member 615 in contact therewith, such as a high-temperature insulation material, to cushion the honeycomb body 200 from shock and stress. Any suitable construction of the member 615 may be used, such as one-piece construction, or two or more layer construction. The honeycomb body 200 and member 615 may be received in the can 605 by any suitable means, such as by funneling into the central body and then one or more of the first and second end caps may be secured (e.g., welded) onto the central body for form the inlet 607 and the outlet 609. Other, two-piece construction or clam-shell construction of the can 605 can be optionally used.

FIG. 7 illustrates an exhaust system 700 coupled to an engine 717 (e.g., a gasoline engine or diesel internal combustion engine). The exhaust system 700 may comprise a manifold 719 configured for coupling to the exhaust ports of the engine 717, a first collection tube 721 configured to couple between the manifold 719 and the catalytic converter 600 containing the honeycomb body 200 (shown dotted) therein. Coupling may be by any suitable clamping bracket or other attachment mechanism, such as welding. Furthermore, the first collection tube 721 may be integral with the manifold 719 in some embodiments. In some embodiments, the catalytic converter 600 may couple directly to the manifold 719 without an intervening member. The exhaust system 700 may further comprise a second collection tube 723 coupled to the catalytic converter 600 and to a second exhaust component 727. The second exhaust component 727 may be a muffler, another of a same type or different type of catalytic converter, or a particulate filter, for example. A tailpipe 729 (shown truncated) or other flow conduit may be coupled to the second exhaust component 727. Other exhaust system components may be included, such as other catalytic converters, particulate filters, partial filters, oxygen sensors, ports for urea injection, and the like (not shown). In some embodiments, the engine 717 may comprise one catalytic converter 600 for each bank (side set of cylinders) of the engine 717 in which case the second collection tube 723 may be a Y-tube, or optionally, the first collection tube 721 may be a Y-tube collecting exhaust flow from each bank and directing the flow to the catalytic converter 600.

Utilizing the catalytic converter 600 comprising the honeycomb body 200 according to embodiments described herein may result in fast light-off (FLO) properties in combination with excellent iso-static strength and lower cpsi while providing equivalent hydraulic area so that low back pressure is retained.

Moreover, more effective wall surface area may be provided, thus advantageously less catalyst may be applied to the walls resulting in equivalent or better effective oxidation and/or reduction reactions relative to traditional catalytic converters. Moreover, relatively-lower back pressure exerted by the honeycomb body 200 in the exhaust system 700 when catalyst coated may be provided due to the lesser amount of applied wash coating. This may allow for free exhaust flow and thus substantially minimal power reduction of the engine 717. Overall catalyst cost is also reduced, due to the minimization of corner puddling.

Referring now to FIGS. 8A-8B, the honeycomb extrusion die 34 (FIG. 1A) configured to manufacture the honeycomb body 200 or optionally, honeycomb structures including any one of embodiments described herein is provided. The honeycomb bodies may be formed by extrusion of a plasticized batch, which is described, for example, in U.S. Pat. Nos. 3,885,977, 5,332,703, 6,391,813, 7,017,278, 8,974,724, WO2014/046912, and WO2008/066765, through the honeycomb extrusion die 34 to produce a wet honeycomb body. The wet honeycomb body may then be dried, such as described in U.S. Pat. Nos. 9,038,284, 9,335,093, 7,596,885, and 6,259,078, for example, to produce a green honeycomb body. The green honeycomb body may then be fired, such as described in U.S. Pat. Nos. 9,452,578, 9,446,560, 9,005,517, 8,974,724, 6,541,407, or U.S. Pat. No. 6,221,308 to form the honeycomb body 200 or other honeycomb structures described herein comprising triangular-shaped channels 208. Other suitable forming, drying, and/or firing methods may be used.

The honeycomb extrusion die 34 can comprise a die body 839 such as a metal disc, a die inlet face 842 configured to receive the plasticized batch composition from an extruder, and a die outlet face 844 opposite from the die inlet face 842 and configured to expel plasticized batch in the form of a green honeycomb extrudate. The honeycomb extrusion die 34 may be coupled to an extruder (such as the twin-screw extruder apparatus 20 (FIG. 1A) or other extruder type) that receives the batch composition and forces the batch composition under pressure through the honeycomb extrusion die 34.

The honeycomb extrusion die 34 may comprise a plurality of feedholes 845 (a few labeled) extending from the die inlet face 842 into the die body 839. The plurality of feedholes 845 intersect with an array of slots 848 (a few labeled) extending into the die body 839 from the die outlet face 844. The plurality of slots 848 may have a slot thickness Sk measured transversely across the slots 848. The slot thickness Sk may be selected based on the total shrinkage of the batch composition that is used (e.g., shrinkage from extrusion through firing) so that the fired honeycomb body has a transverse wall thickness Tk (FIG. 3C) of the porous walls 220 (FIG. 3B) of between about 2 mils and 12 mils (51 to 300 μm). For example, for a nominal extrude-to-fire shrinkage of 12%, the slot thickness Sk and may be selected to be less 12% greater than the transverse wall thickness Tk (FIG. 3C) of the porous walls 220.

The plurality of feedholes 845 connect with, and can be configured to feed batch composition to, the slots 848. The array of slots 848 intersect with one another and themselves as shown in FIG. 8A. The array of slots 848 form an array of die pins 855 (a few labeled) that are arranged in a die pin structure across the die outlet face 844.

In the depicted embodiment, the slots 848 may be formed by abrasive wheel slotting or by a wire electron discharge machining (EDM) process, for example. Other suitable die manufacturing methods may be used. The fillets formed at the vertices can be formed by plunge EDM or other suitable method, such as micro-machining. Each of the array of die pins 855 may be triangular in transverse cross-sectional shape. The honeycomb extrusion die 34 may comprise a skin-forming portion 800S comprising a skin-forming mask 849 (e.g., a ring-shaped article) that interfaces with batch from the skin forming feedholes 845S and recessed skin-forming region outboard of the die outlet face 844 to form an extruded skin on the green honeycomb extrudate formed during the extrusion method.

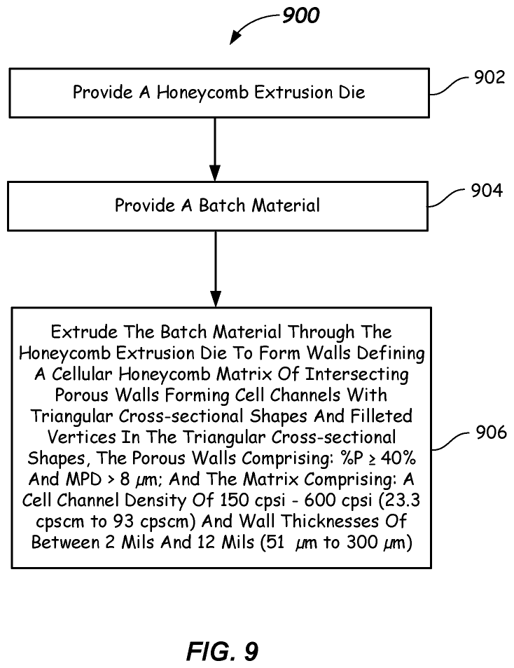

In another aspect, a method of manufacturing a honeycomb structure (e.g., honeycomb body 200) is provided. Reference is made to a flowchart of the method 900 of FIG. 9 where the method is described. The method 900 comprises, in 902, providing an extrusion die (e.g., honeycomb extrusion die 34). The method 900 comprises, in 904, providing a batch material (e.g., batch material 33). In 906, the method 900 comprises extruding the batch material through the extrusion die to form walls (e.g., walls 220) defining a cellular honeycomb matrix (e.g., honeycomb matrix 226) of intersecting porous walls forming cell channels (e.g., channels 208) with triangular cross-sectional shapes (see FIG. 3A-3C) and filleted vertices (e.g., vertices 328) in the triangular cross-sectional shapes. The porous walls comprise: % P≥40% and MPD>8 μm; and the matrix comprises: a cell channel density of 150 cpsi to 600 cpsi (23.3 cpscm to 93 cpscm) and wall thicknesses of between 2 mils and 12 mils (between 51 μm and 300 μm).

The foregoing description discloses numerous example embodiments of the disclosure. Modifications of the above-disclosed honeycomb bodies, extrusion dies, and methods that fall within the scope of the disclosure will be readily apparent. For example, any combination of the parameters disclosed herein with respect to one embodiment, may be applied to other honeycomb body embodiments disclosed herein. Accordingly, while the present disclosure includes certain example embodiments, it should be understood that other embodiments may fall within the scope of the disclosure, as defined by the claims.

1. A honeycomb body comprising:
a cellular honeycomb matrix of intersecting porous walls forming cell channels with triangular cross-sectional shapes and filleted vertices in the triangular cross-sectional shapes, the intersecting porous walls comprising:
% P≥40%; and
MPD>8 μm; and
the cellular honeycomb matrix comprising:
a cell channel density of 150 cpsi to 600 cpsi; and
wall thickness of between 2 mils and 12 mils.

2. The honeycomb body of claim 1, wherein the filleted vertices comprise corner radii that are greater than or equal to 0.001 inch.

3. The honeycomb body of claim 1, further comprising a wash coat applied to the intersecting porous walls.

4. The honeycomb body of claim 3, wherein the wash coat is predominantly carried in the intersecting porous walls.

5. The honeycomb body of claim 1, wherein one or more cell channels have a hydraulic diameter of 1.00 mm or greater.

6. The honeycomb body of claim 1, wherein the wall thickness is less than 0.006 inch.

7. The honeycomb body of claim 1, comprising an open frontal area of 83% or more.

8. The honeycomb body of claim 1, comprising a 40%≤% P≤70%.

9. The honeycomb body of claim 1, comprising an 8 μm<MPD<30 μm.

10. A method of manufacturing a honeycomb body, the method comprising:
extruding batch material through an extrusion die to form walls defining a cellular honeycomb matrix of intersecting porous walls forming cell channels with triangular cross-sectional shapes and filleted vertices in the triangular cross-sectional shapes, the intersecting porous walls comprising:
% P≥40%; and
MPD≥8 μm;
the cellular honeycomb matrix comprising:
a cell channel density of 150 cpsi to 600 cpsi; and
wall thickness of between 2 mils and 12 mils.

11. The method of claim 10 wherein the filleted vertices comprise corner radii that are greater than or equal to 0.001 inch.

12. The method of claim 10 further comprising applying a catalytic material to the intersecting porous walls.

13. The method of claim 12 wherein applying the catalytic material comprises applying a wash coat.

14. The method of claim 10 wherein one or more cell channels have a hydraulic diameter of 1.00 mm or greater.

15. The method of claim 10 wherein the wall thickness is less than 0.006 inch.

16. The method of claim 10 comprising an open frontal area of 83% or more.

17. The method of claim 10 comprising a 40%≤% P≤70%.

18. The method of claim 10 comprising an 8 μm<MPD<30 μm.

19. A honeycomb body comprising:
a cellular honeycomb matrix of intersecting porous walls forming cell channels with triangular cross-sectional shapes and filleted vertices in the triangular cross-sectional shapes, the intersecting porous walls comprising:
% P≥40%; and
8 μm<MPD<30 μm;
the cellular honeycomb matrix comprising:
a cell channel density of 200 cpsi to 400 cpsi; and
wall thickness of 6 mils or less.

20. The honeycomb body of claim 19 further comprising a catalytic material disposed in or on the intersecting porous walls.
